(19) United States
(12) Patent Application Publication
(10) Pub. No.: US 2008/0160363 A1
(43) Pub. Date: Jul. 3, 2008

(54) Control of the Polymer Humidifying Membrane of a Fuel Cell

(76) Inventor: Akinori Tsukada, Kirchdorf AG (CH)

Correspondence Address: Thomas Langer;Cohen Pontani Lieberman & Pavane, Suite 1210, 551 Fifth Avenue, New York, NY, 10176, US

(21) Appl. No.: 11/658,195

(22) PCT Filed: Jun. 27, 2005
(86) PCT No.: PCT/EP2005/006889

§ 371 Date: Sep. 25, 2007

(30) Foreign Application Priority Data
Jul. 20, 2004 (FR) 0408057

(51) Int. Cl. H01M 8/18

(52) U.S. Cl. 429/19

(57) ABSTRACT

An electricity production system comprising a fuel cell (1) with a plurality of individual cells each comprising an anode and a cathode on either side of a solid electrolyte having optimum operating characteristics in predetermined humidification conditions. The fuel cell has a fuel gas feed circuit (11) on the anode side, a feed circuit for a combustion-supporting gas on the cathode side and at least one recycling circuit (12+13) for one of the fuel or combustive gases which recycles the gas not consumed by the fuel cell. The recycling circuit comprises a dehumidifier (3) which enables the water contained in the unconsumed gas to be removed therefrom. The recycling circuit collects a moist gas downstream from the fuel cell, passing the moist gas to the dehumidifier and returning a dehumidified gas to the feed circuit (11) upstream from the fuel cell after the gas has passed through the dehumidifier. The recycling circuit comprises a direct circuit (15) installed in parallel with the dehumidifier which taps off some of the moist gas downstream from the fuel cell and passes the moist gas into the feed circuit (11) without passing through the dehumidifier (3). Measuring means control the proportion between the moist gas and the dehumidified gas returned upstream from the cell.

### FIELD OF THE INVENTION

The present invention concerns fuel cells, in particular the automobile applications of fuel cells.

### PRIOR ART

As is known, fuel cells enable the direct production of electrical energy by an electrochemical redox reaction between hydrogen (the fuel) and oxygen (the combustion-supporting gas), without proceeding via conversion into mechanical energy. This technology seems promising in particular for automobile applications. A fuel cell generally comprises an association in series of unitary elements each consisting essentially of an anode and a cathode separated by an electrolyte.

One type of electrolyte which lends itself well to automobile applications is a solid electrolyte consisting essentially of a polymer membrane which allows ions to pass between the anode and cathode. A particular type of such membranes is proposed for example by the company DuPont under the trade name “Nafion”. These membranes must have good ionic conductivity because they are traversed by hydrogen protons and they must be electrically insulating so that electrons will move through the electric circuit external to the cell. As is known, not just for membranes of the type indicated above but also for other membranes used as solid electrolytes in fuel cells, the conductivity of the membranes is a function of their water content. For that reason the gases fed to the cell must contain sufficient moisture.

As regards the fuel, either a supply of hydrogen is available or the hydrogen needed is produced near the fuel cell by a reformer itself supplied for example with a hydrocarbon. As regards the combustive gas, either the fuel cell is supplied with compressed atmospheric air and excess gas with a reduced oxygen content is discharged downstream from the cell, or the fuel cell is supplied with pure oxygen.

During normal operation a fuel cell consumes hydrogen (the fuel) and oxygen (the combustive gas, provided by the ambient air or in the form of the pure gas). The fuel cell is the site of an anodic reaction in which hydrogen (H₂) is transformed into hydrogen protons (2H⁺) which pass through the polymer membrane and into electricity (2e⁻) which combines with oxygen (½ O₂) to produce water (H₂O). Thus, the fuel cell continually produces water, essentially in the cathode gas (oxygen) circuit and in amounts proportional to the electric current taken up by the electric load connected across the cell. Accordingly, the gas on the cathode side quickly becomes saturated with water and even supersaturated (i.e. besides water in gaseous form it also contains water in liquid form).

Patent application US 2002/0175010 indicates that classically, the water produced by the cell is used to ensure the humidification of the polymer membrane, both on the cathode and on the anode side. As regards the humidification of the membrane on the anode side, i.e. in the hydrogen circuit, it is proposed in particular to use a water-permeable membrane one of whose faces is in contact with the air supersaturated with water while the other face is in contact with the hydrogen. This solution, however, besides being complex, does not enable real regulation of the amount of humidity in the gas.

Patent application JP2004/079251 describes the dehumidification of the hydrogen produced in an electrolyser or in a reformer. The hydrogen to be dehumidified does not come from recycling. It is proposed to control the humidification of the hydrogen by mixing dehumidified hydrogen coming from a dehumidifier with very moist hydrogen circulating in a bypass circuit which does not pass through the dehumidifier, this latter flow being controlled by means of a proportional valve in the said bypass circuit.

Patent application EP 1 389 806 describes a fuel cell with a solid polymer electrolyte, having a particular arrangement of the cell's internal ducts so as to improve a water retention zone inside the cell in order to control the humidification. Patent application JP09/180743 proposes to control the humidity level by acting on the temperature of the water separators. All these publications address the problem of humidifying a cell with a solid polymer electrolyte, but none of them proposes a reliable and precise system for ensuring correct humidification of the polymer membrane electrolyte under all circumstances.

### BRIEF DESCRIPTION OF THE INVENTION

The purpose of the present invention is to propose means that enable optimisation of the humidity level of a gas or gases feeding a fuel cell whose electrolyte is such that the fuel cell has optimum operating characteristics in predetermined humidification conditions. This is known to be the case, among the electrolytes known at present, for a type of electrolyte consisting essentially of a solid polymer membrane.

The invention proposes an electricity production system comprising:
a fuel cell comprising a plurality of individual cells each with an anode and a cathode on either side of a solid electrolyte having optimum operating characteristics in predetermined humidification conditions, the fuel cell having a fuel gas feed circuit on the anode side and a combustive gas feed circuit on the cathode side;
at least one recycling circuit for one of the fuel or combustive gases, which recycles the gas not consumed by the fuel cell, the recycling circuit comprising a dehumidifier which enables the water contained in the unconsumed gas to be removed therefrom, the recycling circuit collecting a moist gas downstream from the fuel cell, passing the moist gas to the dehumidifier and returning a dehumidified gas to the feed circuit upstream from the fuel cell after the gas has passed through the dehumidifier;
   characterised in that the recycling circuit comprises a direct circuit installed in parallel with the dehumidifier, which taps off some of the moist gas downstream from the fuel cell and passes the moist gas into the feed circuit without passing through the dehumidifier, and in that it comprises measuring means for controlling the respective proportions between the moist gas and the dehumidified gas returned upstream from the cell.

### BRIEF DESCRIPTION OF THE FIGURES

All aspects of the invention are made clear by the remainder of the description, which refers to the single figure illustrating the cooling circuit installed in an automobile vehicle equipped with a fuel cell.

### DESCRIPTION OF THE MOST SUITABLE EMBODIMENT OF THE INVENTION

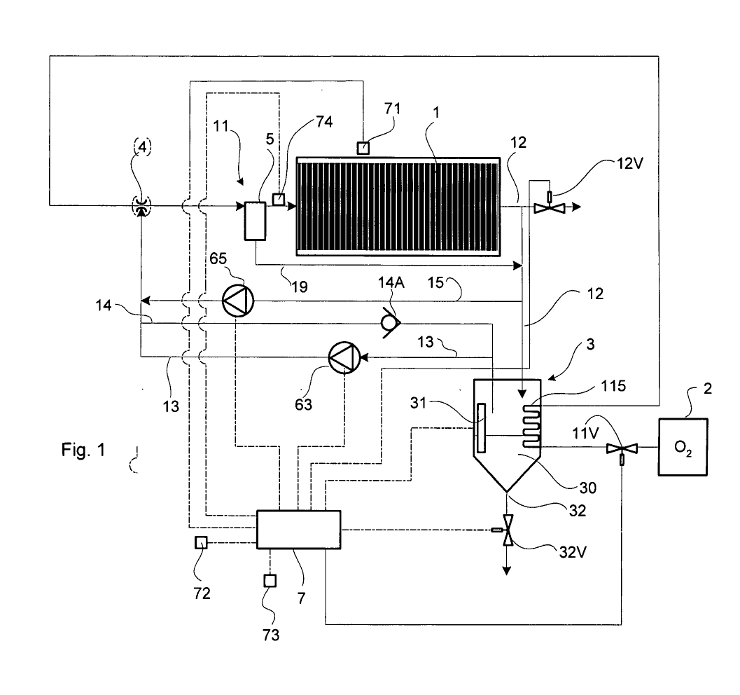

FIG. 1 shows a fuel cell 1 of the type with an electrolyte in the form of a polymer membrane (i.e. of the PEFC—Polymer Electrolyte Fuel Cell—type). However, the invention is applicable to any electrolyte for which the fuel cell would show optimum operating characteristics in controlled gas humidification conditions.

The cell is supplied with two gases, namely the fuel (for example hydrogen) and the combustive gas (oxygen from the air or from a tank of compressed oxygen), which feed the electrodes of the electrochemical cells. For simplicity, FIG. 1 shows only one of the two gas circuits, namely a circuit for the gas on the cathode side which is in this case an oxygen circuit (see O₂ feed in the figure). It is of course understood that the same arrangement can be adopted on the hydrogen side. The remainder of the description is restricted to a recycling circuit for the combustive gas, i.e. the circuit on the cathode side, without this being in any way limiting.

The figure shows a tank 2 of oxygen, connected to the cell by an intake pipe 11 which passes through various elements before being connected to the inlet of the fuel cell 1. This intake pipe 11 first passes via a cutoff valve 11v and if necessary via other valves (not shown). It is evident that the oxygen circuit forms a loop, because the gas flow passing through the cell is larger than the amount consumed and the flow not consumed by the cell is recycled. For that purpose, the feed circuit 11 then passes through an ejector 4. Then, there is a water separator 5 consisting for example of a cyclone, i.e. a device that enables liquid water to be removed from the gas by centrifugal action. At the lower outlet of this cyclone 5 a pipe 19 allows the liquid water to be passed downstream from the fuel cell 1 where it rejoins an outlet pipe 12 for the gases of the fuel cell 1. Finally, the feed circuit 11 is connected to the inlet orifice of the cathode circuit of the fuel cell 1.

At the outlet of the fuel cell 1 the outlet pipe 12 can be seen running to a dehumidifier 3. A purge of the oxygen circuit is connected as a bypass to the outlet pipe 12 and is controlled by a purge valve 12v. The dehumidifier 3 consists essentially of a receptacle which collects the liquid water carried by the gas, by gravity. Just after the cutoff valve 11v it can be seen that the oxygen feed circuit passes via a spiral coil 11s arranged inside the dehumidifier 3. This serves mainly to re-warm the oxygen after its expansion. Moreover, this is useful for bringing about the condensation of the water present in the gas in the form of vapour, which improves the efficiency of the dehumidifier 3.

A water level detector 31 is fitted inside the dehumidifier 3 and a drain pipe runs down to the bottom of the dehumidifier 3. The water is removed by the effect of the pressure in the oxygen circuit of the fuel cell, acting on the surface of the water in the receptacle to eject the water into the drain pipe. The quantity of water ejected is controlled by a drain valve 32v.

A controlled return pipe 13 is connected on one side to the upper part of the dehumidifier 3 and on the other side to the ejector 4. A pump 63 is fitted into this return pipe 13. A passive return pipe 14 is connected on one side to the upper part of the dehumidifier 3 and on the other side to the ejector 4. This passive return pipe 14 is therefore connected in parallel with the controlled return pipe 13. It comprises no pump or other means for the active control of the flow. It contains a one-way valve 14A. The flow through it is brought about by a Venturi effect in the ejector 4.

A direct circuit 15 bypasses the dehumidifier 3. As can be seen, this circuit is connected on one side to the outlet pipe 12 upstream from the dehumidifier 3, and on the other side, ends at the return pipe 13 after the pump 63 and before the ejector 4. This direct circuit 15 comprises a pump 65.

Thus, the recycling circuit is formed by the outlet pipe 12, the controlled return pipe 13, the passive return pipe 14, the direct circuit 15 and by the elements fitted in these pipes and circuit, in particular the pumps 63 and 65 as well as the dehumidifier 3. The controlled return pipe 13 and the passive return pipe 14 form a recycling circuit for dry gas. The direct circuit 15 is a recycling circuit for moist gas.

A control unit 7 enables the control of the various elements of the electrical energy production system using the fuel cell 1. The metering means for the respective proportions of dry gas and moist gas recycled comprise the said control unit 7, which enables selective control of the operation of the pumps 63 and 65.

For that purpose the control unit uses information coming from various sensors such as a temperature sensor 71 of the fuel cell 1, an indicator 72 of the electric power delivered by the cell and/or the electric voltage of each individual cell in the fuel cell battery, or at least some of those cells, the humidity level measured by a humidity sensor 74 installed just at the inlet of the cell 1, oxygen temperature at the inlet of the cell, the temperature of the walls of the dehumidifier 3, the temperature of the cooling water, etc. The control unit 7 enables action upon the cutoff valve 11v or a valve that enables the oxygen feed pressure to be adjusted to the electric power being delivered, or action upon the purge valve 12v for example to carry out from time to time a short purge of the gas in order not to accumulate inert gases that could reduce the efficiency of the cell. The control unit 7 also makes it possible, when the water level in the dehumidifier 3 reaches a maximum detected by the water level detector 31, to open the drain valve 32v for a predefined time, for example of the order of a fraction of a second, to allow some water to escape. Alternatively, this regulation can be done by virtue of a minimum water level detector.

As regards the dose metering means mentioned in the brief description of the invention given earlier, in the particular embodiment to which this description refers they in fact comprise the two pumps 63 and 65, one (65) fitted in the direct circuit and the other (63) in the recycling circuit downstream from the dehumidifier, and also comprise a control unit 7 that enables the operation of the said pumps 63 and 65 to be actuated selectively taking into account, if needs be empirically, the flow of gas recycled due to the Venturi effect in the ejector 4, in order to determine correctly the ratio between the moist gas recycled directly through the direct circuit 15 and the dry gas recycled via the dehumidifier 3. Preferably, the control unit 7 selectively controls the operation of the pumps 63 and 65 as a function of the values transmitted by the humidity sensor 74.

In particular, during start-up phases when the fuel cell 1 is still cold, the control unit 7 sends to the energy management unit also fitted on the vehicle a command to limit the power drawn from the fuel cell 1 and, during the heat up phase of the cell, recycles the gas directly by actuating the pump 65 without actuating the pump 63.

The gas coming from the storage tank 2 is generally cold (despite being warmed in the dehumidifier 3, since it has undergone considerable expansion) and dry. Mixing of this cold gas with the recycled gas enables the temperature and humidity to be increased to sufficient levels without much input of external energy. In effect, the gas emerging directly from the fuel cell 1 and circulating in the outlet pipe 12 is hot and saturated with water vapour, or even supersaturated. The water is eliminated in the dehumidifier 3. Then, the gas circulating in the return line 13 is cooler. Taking into account the conditions prevailing in the fuel cell 1 (cold start, full power, etc.), the control unit 7 can act on the pump 65 (“moist” circulator) to favour the recycling of hot gas free from droplets, or on the pump 63 (“dry” circulator) to favour the recycling of less hot and drier gas, and can produce any ratio between these two types of gas. Accordingly, an optimum mixture of humidified gas for feeding to the fuel cell 1 can be obtained.

In certain operating phases both pumps can be stopped and the recycling can be left to take place just by virtue of the Venturi effect due to the presence of an ejector, which has the advantage of saving energy. Note that the ejector is not obligatory for the implementation of the invention. In a simpler application the ejector could be omitted and replaced by a simple connection, and the passive return pipe 14 could be omitted. The controlled return pipe 13 and the direct circuit 15, with their respective pumps 63 and 65, enable control of the respective proportions of the dry and moist gases.

As a variant, for the combustive gas circuit, feeding with a mixture of oxygen and at least one neutral gas, for example 30% of nitrogen can be provided. However, the application described uses pure oxygen stored under pressure. This solution has some advantages, in particular a more dynamical response of the cell to a demand for current, which is advantageous in particular for applications in transport means such as automobiles, which are known to impose particularly intermittent operating conditions in contrast to static applications. Other advantages of feeding a fuel cell with pure oxygen which can be mentioned are that the efficiency and the power density are better. Furthermore, as regards humidification, this too operates more effectively with pure oxygen than with compressed air. In effect, for the same amount of oxygen used by the cell, if it is fed with air containing only about 21% of oxygen the same quantity of water produced by the cell will be incorporated in a considerably larger volume of gas. So to achieve the same gas humidity level, about 5 times as much water will have to be vaporised.

1. An electricity production system comprising:
a fuel cell (1) comprising a plurality of individual cells each having an anode and a cathode on either side of a solid electrolyte which has optimum operating characteristics in predetermined humidification conditions, the fuel cell having a fuel gas supply circuit (11) on the anode side and a combustive gas circuit on the cathode side; and
at least one recycling circuit for one of the fuel or combustive gases, which recycles the gas not consumed by the fuel cell, said recycling circuit comprising a dehumidifier (3) which enables the water contained in the unconsumed gas to be removed, the recycling circuit collecting a moist gas downstream from the fuel cell, passing the moist gas to the dehumidifier and passing a dehumidified gas into the fuel gas supply circuit (11) upstream from the fuel cell after the gas has been through the dehumidifier;
wherein said the recycling circuit comprises
a controlled recycling pipe (13) comprising a pump (63), the controlled recycling pipe (13) being installed downstream from the dehumidifier (3),
a direct circuit (15) installed in parallel with the dehumidifier, said direct circuit (15) comprising a pump (65), the direct circuit (15) tapping off the moist gas downstream from the fuel cell and passing the moist gas into the feed circuit (11) without passing through the dehumidifier (3), and
metering means for controlling the respective proportions between the moist gas and the dehumidified gas returned upstream from the fuel cell.

2. The system according to claim 1, in which the recycling circuit comprises a passive recycling line (14) installed in parallel with the controlled recycling line (13).

3. The system according to claim 2, in which the recycling circuit leads to an ejector (4) installed in the gas feed circuit.

4. The system according to claim 1, in which the dose metering means comprise a control unit (7) that enables the operation of the pumps (63 and 65) to be actuated selectively.

5. The system according to claim 1, in which the control unit (7) controls the operation of the pumps (63 and 65) selectively as a function of the values transmitted by a humidity sensor (74).

6. The system according to claim 1, comprising a recycling circuit in the combustive gas circuit.

7. The system according to claim 1, in which the combustive gas circuit is a pure oxygen supply circuit.

8. The system according to claim 1, in which the combustive gas circuit is a circuit feeding a mixture of pure oxygen and at least one neutral gas.

9. The system according to claim 1, in which the fuel cell is of the type with a polymer membrane.

10. The system according to claim 1, for an automobile vehicle.
